(19) United States
(12) Patent Application Publication
(10) Pub. No.: US 2017/0265237 A1
(43) Pub. Date: Sep. 14, 2017

(54) BODY AREA NETWORK DATA TRANSMISSION METHOD, BODY SENSING DEVICE, AND BODY AREA NETWORK SYSTEM

(71) Applicant: BEIJING ZHIGU TECH CO., LTD., BEIJING (CN)

(72) Inventors: HAO LIU, BEIJING (CN); WEICAI HUANG, BEIJING (CN)

(21) Appl. No.: 15/510,000

(22) PCT Filed: Aug. 26, 2015
(86) PCT No.: PCT/CN2015/088083

§ 371 Date: Mar. 9, 2017

(30) Foreign Application Priority Data
Sep. 11, 2014 (CN) 201410459754.3

(51) Int. Cl. H04W 76/02; H04B 17/318; H04W 4/00

(52) U.S. Cl. CPC H04W 76/023; H04W 4/008; H04B 17/318; H04W 84/18

(57) ABSTRACT

A body area network data transmission method comprises: when a first body sensing device cannot establish a direct communication connection with a body central device, establishing communication with the body central device by using at least one second body sensing device. Technical solutions of the embodiments of the subject application improve an effect of communication between a body sensing device and a body central device in a body area network, thereby avoiding insufficient detection of user health or the like due to blocked communication.

### RELATED APPLICATION

The present international patent cooperative treaty (PCT) application claims the benefit of priority to Chinese Patent Application No. 201410459754.3, filed on Sep. 11, 2014, and entitled “Body Area Network Data Transmission Method, Body Sensing Device, and Body Area Network System”, which is hereby incorporated into the present international PCT application by reference herein in its entirety.

### TECHNICAL FIELD

The subject application relates to body area network technologies, and in particular, to body area network data transmission, body sensing, and body area network systems.

### BACKGROUND

A body area network is a wireless network comprising at least one wearable body sensing device. Generally, the body area network comprises multiple body sensing devices, such as an electrocardiograph sensor and a respiration sensor, and one body central device.

The body sensing device may be implanted to, attached to, or carried on the front and back of a human body, and the body central device is connected to the Internet or a local area network as a gateway of the body area network.

Generally, a body sensing device and a body central device in a body area network can be connected to each other by using a wireless technology such as Nordic Radio, or Bluetooth. For example, in a hospital, a patient is monitored by doctors by a health body area network. There are body sensing devices on the front and back of the body of the patient. A body central device may generally comprise a fixed base station, and may perform bidirectional communications with the multiple body sensing devices.

### SUMMARY

Embodiments of the subject application provides a body area network data transmission technology.

According to a first aspect, an embodiment of this application provides a body area network data transmission method includes

determining whether it is suitable for a first body sensing device to establish a direct communication connection with a body central device,

if not, establishing communication with the body central device by using at least one second body sensing device.

According to a second aspect, an embodiment of this application provides a body sensing device, a communications module, configured to:

determine whether it is suitable for the body sensing device to establish a direct communication connection with a body central device,

if not, establish communication with the body central device by using at least one second body sensing device.

According to a third aspect, an embodiment of this application provides a body area network system, comprising a communications module, configured to: when a first body sensing device is not suitable to establish a direct communication connection with a body central device, establish communication with the body central device by using at least one second body sensing device; at least one second body sensing device; and a body central device.

According to a fourth aspect, an embodiment of this application provides a computer readable storage device comprising executable instructions that, in response to execution, causes the device to: determine whether that it is suitable for a first body sensing device to establish a direct communication connection with a body central device, and if not, establish communication with the body central device by using at least one second body sensing device.

In at least one embodiment of the subject application, when it is not suitable for one or more body sensing devices on the body of a user to communicate with a body central device, other body sensing device(s) for which it is suitable to communicate with the body central device will be used for the communication between the one or more body sensing devices and the body central device, which improves an effect of communication between a body sensing device and a body central device in a body area network, thereby avoiding insufficient detection of user health or the like due to blocked communication.

### BRIEF DESCRIPTION OF THE DRAWINGS

FIG. 1 is a flowchart of a body area network data transmission method according to an embodiment of the subject application;

FIG. 2 is a schematic diagram of a body area network data transmission method according to an embodiment of the subject application;

FIG. 3 is a schematic structural block diagram of a body sensing device according to an embodiment of the subject application;

FIG. 4a is a schematic structural block diagram of a body sensing device according to an embodiment of the subject application;

FIG. 4b is a schematic structural block diagram of a body sensing device according to an embodiment of the subject application;

FIG. 4c is a schematic structural block diagram of a body sensing device according to an embodiment of the subject application;

FIG. 4d is a schematic structural block diagram of a second connection determining module of a body sensing device according to an embodiment of the subject application;

FIG. 4e is a schematic structural block diagram of a body sensing device according to an embodiment of the subject application;

FIG. 5 is a schematic structural block diagram of a body area network system according to an embodiment of the subject application; and

FIG. 6 is a schematic structural block diagram of still another body sensing device according to an embodiment of the subject application.

### DETAILED DESCRIPTION

Specific embodiments of the subject application are described in further detail below with reference to the accompanying drawings (in which same reference numerals indicate same elements). The following embodiments are used to describe the subject application, but are not used to limit the scope of the subject application.

It can be understood by a person skilled in the art that terms such as “first” and “second” in the subject application are used only to differentiate different steps, devices, modules, or the like, and indicate neither any specific technical meanings nor any necessary logical sequence therebetween.

In the following descriptions of embodiments of the subject application, a body sensing device is a body sensor, which is generally worn on the body of a user (in some cases, may also be implanted into the body of a user), and is configured to collect at least one type of data related to the body of the user, including a body temperature, electrocardiograph, a cardiac rate, or a blood oxygen content, for health detection, emotion monitoring, or the like of the user. To monitor and process the data collected by the body sensor conveniently and collectively in real time, generally, at least one body central device that performs wireless communication with the body sensing device needs to be disposed. The body central device is connected to a local area network and the Internet as a gateway of a body area network.

According to some embodiments of the subject application, one or more body sensing devices of multiple body sensing devices may be disposed on the different sides of a body of the user; because human bodies absorb wireless signals, in this situation, communication between these body sensing devices may be blocked by the body and the body central device is affected, or even cannot be performed. Therefore, as shown in FIG. 1, an embodiment of the subject application provides a body area network data transmission method, comprising:

S110. determine whether it is suitable for a first body sensing device to establish a direct communication connection with a body central device,

if not, establish communication with the body central device by using at least one second body sensing device.

For example, as an execution body of this embodiment, a first body sensing device provided by the subject application performs S110. The first body sensing device comprises but is not limited to: an electrocardiograph sensor, a respiration sensor, and a body temperature sensor.

In this embodiment of the subject application, when it is not suitable for a first body sensing devices on the body of a user to communicate with a body central device, other body sensing device(s) suitable to communicate with the body central device will be used for the communication between the one or more body sensing devices and the body central device. This improves communication between a body sensing device and a body central device in a body area network, thereby avoiding insufficient detection of user health or the like due to blocked communication.

Steps of this embodiment of the subject application are further described by using the following implementation manner:

In an implementation manner of this embodiment of the subject application, a case in which it is not suitable to establish a direction communication connection between a body sensing device and a body central device comprises at least one of the following:

1. Strength of at least one detection signal acquired by a first body sensing device is less than a set strength threshold.

In this implementation manner, when strength of the detection signal acquired by the first body sensing device is less than the set strength threshold, it indicates that there is a human body or other object that affects receiving of the detection signal between the first body sensing device and the body central device, which causes that communication between the first body sensing device and the body central device is blocked. In this situation, it is not suitable for the first body sensing device to establish a direct communication connection with the body central device.

2. The first body sensing device does not obtain at least one detection signal in a set detection signal sending condition.

In this implementation manner, in a case in which a transmission channel of the detection signal is seriously blocked, it is possible that the first body sensing device cannot receive the at least one detection signal at all; in this case, it may be determined, according to a fact that the first body sensing device does not obtain the at least one detection signal in a set detection signal sending condition, that at this time it is not suitable for the first body sensing device to establish a direct communication connection with the body sensing device.

In a possible implementation manner, the at least one detection signal is sent out at a set period, for example: the at least one detection signal is sent out every 0.1 seconds. In this implementation manner, the detection signal sending condition comprises that: timing meets set period duration. That is, when the first body sensing device does not receive the at least one detection signal within duration (for example, 0.1 seconds described above) corresponding to the period, it may be determined that it is not suitable for the first body sensing device to establish a direct communication connection with the body central device.

A location of the user changes from one side of the body central device to the other side of the body central device, or a gesture of the body of the user changes, which causes that a body sensing device that previously faces the body central device changes to be blocked by the human body and back to the body central device, causing that a communication condition between the body sensing device on the body of the user and the body central device changes; therefore, in another possible implementation manner, the at least one detection signal is sent out according to triggering by a trigger signal, for example, when a change in the location or the body gesture of the user meets a set standard, the trigger signal is generated. Therefore, the detection signal sending condition comprises:

motion posture change information of a user meets a set standard, where the user is a user using the first body sensing device and the at least one second body sensing device.

The set standard herein can be, for example, that: displacement of a user meets a set distance; and/or the body of a user rotates at a set angle, or the like.

Certainly, it can be known by a person skilled in the art that the detection signal sending condition may also be other condition(s) that may trigger sending of the detection signal.

3. The first body sensing device cannot send at least one signal to the body central device to a set data transmission standard.

In this implementation manner, the data transmission standard may comprise, for example, at least one of the following: sending out data within a preset time period, a data transmission speed, and the like.

For example, when data cannot be sent out within the preset time period, it may be determined that it is not suitable for the first body sensing device to establish a direct connection with the body central device.

In a possible implementation manner of the foregoing implementation manners 1 and 2, the at least one detection signal may be sent out by the body central device. Therefore, the method further comprises: acquiring the at least one detection signal from the body central device. Certainly, it can be known by a person skilled in the art that the at least one detection signal may also be sent out by other device related a location of the body central device.

It can be known by a person skilled in the art that, in addition to the foregoing several cases in which it is not suitable for the first body sensing device to establish a direct communication connection with the body central device, there may be other possible cases that may also cause that it is not suitable for the first body sensing device to be in a direct communication connection with the body central device, and these possible cases may also be comprised in the protection scope of the subject application.

In a possible implementation manner, the establishing communication with the body central device at least by using at least one of at least one second body sensing device comprises:

in response to a fact that the first body sensing device has a direct communication connection channel with at least one of the at least one second body sensing device:

establishing communication with the body central device by using the at least one of the at least one second body sensing device.

In a possible implementation manner, the direct communication connection channel between the first body sensing device and the second body sensing device may be, for example: a wired connection channel, or a channel using a human body as a connection medium.

In a possible implementation manner, the establishing communication with the body central device at least by using at least one of at least one second body sensing device further comprises:

in response to a fact that the first body sensing device has no direct communication connection channel with at least one of the at least one second body sensing device:

establishing communication with the body central device by using a third body sensing device that has a direct communication connection channel with at least one of the at least one second body sensing device, and the at least one of the at least one second body sensing device, where

it is not suitable for each of the a third body sensing device to be directly connected to the body central device.

It can be known by a person skilled in the art that, in the implementation manners of this embodiment of the subject application, the first body sensing device and the second body sensing device are only marks of a body sensing device when the body sensing device is in different states of communication with the body central device. For example, when it is not suitable for a body sensing device to directly communicate with the body central device, the body sensing device is classified as the first body sensing device, and when it is suitable for the body sensing device to directly communicate with the body central device, the body sensing device can be classified as the second body sensing device.

For example, when strength of at least one detection signal acquired by a body sensing device is not less than a set strength threshold, and/or the body sensing device can obtain at least one detection signal in a set detection signal sending condition, and/or the body sensing device can send at least one signal to the body central device to a set data transmission standard, it may also be determined that it is suitable for the body sensing device to establish a direction connection with the body central device; in this case, the first body sensing device may be classified as one of the at least one second body sensing device, and correspondingly, the body sensing device establishes direct communication with the body central device without using any other body sensing device.

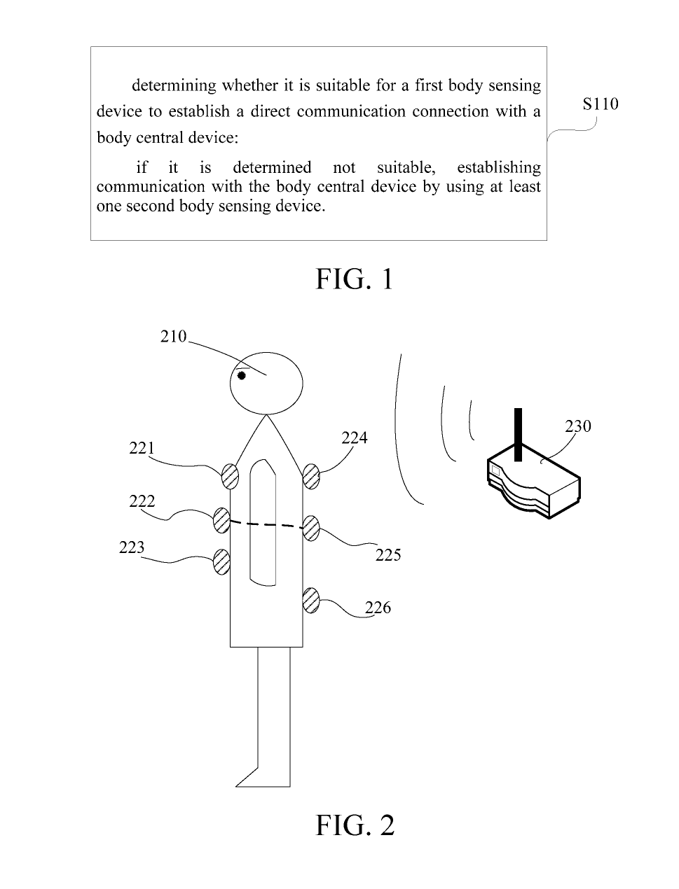

This embodiment of the subject application is described by using an embodiment shown in FIG. 2:

As shown in FIG. 2, for example, a user 210 wears six body sensing devices 221 to 226, which form a body area network, and can directly perform bidirectional communications with a body central device 230 if in a good communication condition. The body central device 230 sends a detection signal to the six body sensing devices 221 to 226 at a period.

A body sensing device 222 on the front of the user is connected to a body sensing device 225 on the back of the user in a wired manner.

It can be seen from FIG. 2 that when the user is in a current gesture, three body sensing devices 224 to 226 on the back of the user face the body central device 230, and at this time, strength of the detection signals received by the three body sensing devices 224 to 226 meet a strength threshold, and it is suitable for the three body sensing devices 224 to 226 to establish direct communication connections with the body central device 230; in this case, the three body sensing devices 224 to 226 can be classified as the second body sensing devices described above. Correspondingly, three body sensing devices 221 to 223 on the front of the user are blocked by the body of the user, and therefore, strength of the detection signals received by the body sensing devices 221 to 223 is less than the strength threshold or even the three body sensing devices 221 to 223 cannot receive the detection signals at all; in this case, the three body sensing devices can be classified as the first body sensing devices described above.

At this time, it is not suitable for the body sensing device 222 to establish a direct communication connection with the body central device 230; however, the body sensing device 222 has a direction connection channel with the body sensing device 225 of the second body sensing devices, and therefore, the body sensing device 222 may communicate with the body central device 230 by using the body sensing device 225. It is not suitable for the body sensing device 221 and the body sensing device 223 to establish direct communication connections with the body central device 230; in addition, the body sensing device 221 and the body sensing device 223 have no direction connection channels with the three second body sensing devices, namely, the body sensing devices 224 to 226. In this case, the body sensing device 221 and the body sensing device 223 may communicate with the body central device 230 by using the body sensing device 222 and the body sensing device 225.

It can be known by a person skilled in the art that, when a gesture or location of the user 210 changes, which for example, causes the three body sensing devices 221 to 223 on the front to face the body central device 230, a data transmission situation of the body area network also changes, and it changes to a case that the three body sensing devices 224 to 226 communicate with the body central device 230 directly or indirectly by using the body sensing device 222.

It can be seem from the foregoing description that by using the technical solutions of this embodiment of the subject application, within a normal communication range, regardless of gesture or location of a user, all body sensing devices at different locations on the body of the user can establish good communication connections with a body central device, thereby avoiding that the user cannot seamlessly and continuously collect body sensing data used for health detection due to communication interruption.

It should be understood by a person skilled in the art that in the foregoing method of the specific implementation manner of the subject application, the value of the sequence number of each step does not mean a sequential order of performing the steps, and the order in which the steps are performed should be determined according to the functions and internal logic thereof, and should not constitute any limitation to the implementation process of the specific implementation manner of the subject application.

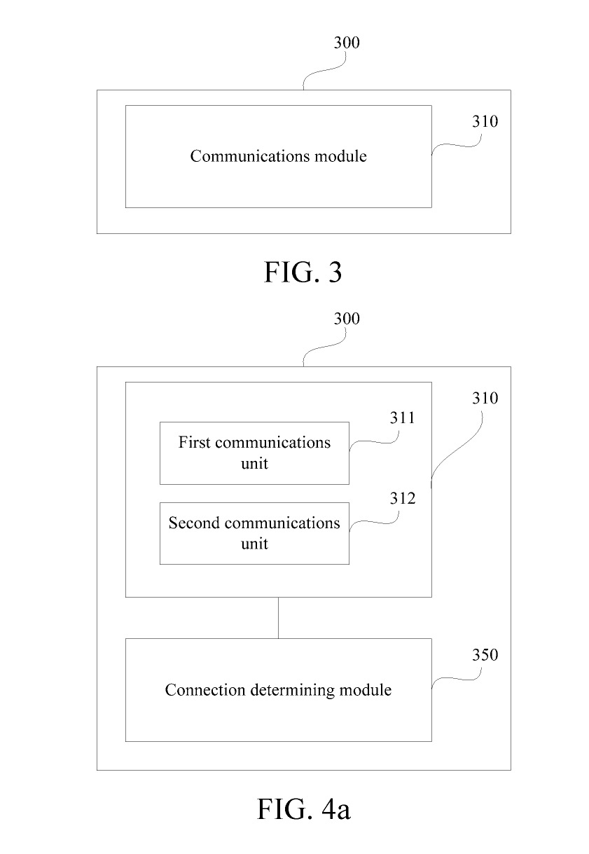

As shown in FIG. 3, an embodiment of the subject application provides a first body sensing device 300, comprising:

a communications module 310, configured to:

determine whether it is suitable for the first body sensing device to establish a direct communication connection with a body central device,

establish communication with the body central device by using at least one second body sensing device.

In this implementation manner of this embodiment of the subject application, when it is not suitable for a first body sensing devices on the body of a user to communicate with a body central device, other body sensing device(s) for which it is suitable to communicate with the body central device will be used for the communication between the one or more body sensing devices and the body central device, which improves an effect of communication between a body sensing device and a body central device in a body area network, thereby avoiding insufficient detection of user health or the like due to blocked communication.

Modules of this embodiment of the subject application are further described by using the following implementation manner:

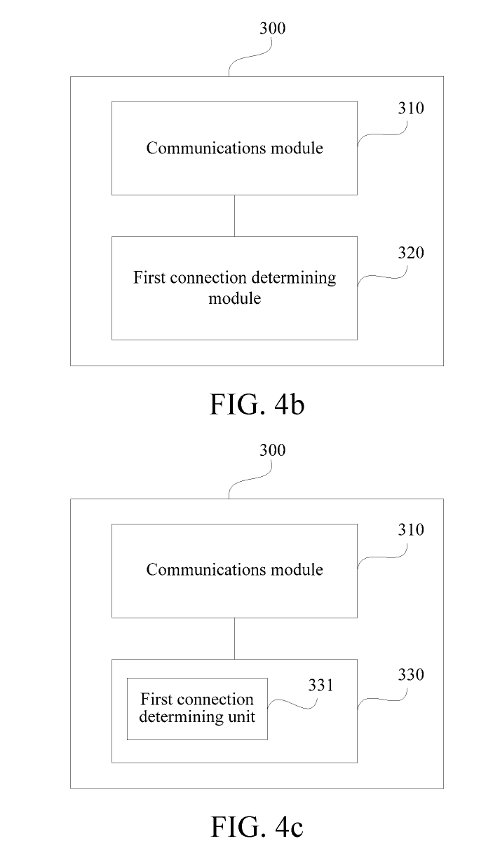

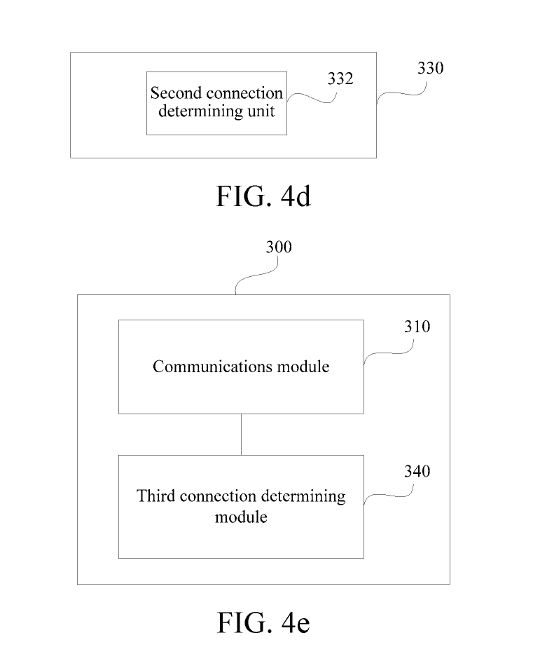

As shown in FIG. 4a, in a possible implementation manner, the device 300 further comprises:

a connection determining module 350, configured to determine that it is not suitable for the body sensing device to establish a direct communication connection with the body central device.

As shown in FIG. 4b, in a possible implementation manner, the device 300 comprises:

a first connection determining module 320, configured to: in response to a fact that strength of at least one detection signal acquired by the first body sensing device is less than a set strength threshold, determine that it is not suitable for the first body sensing device to establish a direct communication connection with the body central device.

In this implementation manner, when strength of the detection signal acquired by the first body sensing device 300 is less than the set strength threshold, it indicates that there is a human body or an object that affects receiving of a detection signal between the first body sensing device and the body central device, which causes that communication between the first body sensing device and the body central device is blocked. At this time, the first connection determining module 320 may determine that it is not suitable for the first body sensing device to establish a direct communication connection with the body central device.

In a possible implementation manner, the at least one detection signal may be sent out by the body central device. Therefore, in a possible implementation manner, the first connection determining module 320 is further configured to acquire the at least one detection signal from the body central device. Certainly, it can be known by a person skilled in the art that the at least one detection signal may also be sent out by another device related a location of the body central device.

As shown in FIG. 4c, in a possible implementation manner, the device 300 comprises:

a second connection determining module 330, configured to: in response to a fact that the first body sensing device does not obtain at least one detection signal in a set detection signal sending condition, determine that it is not suitable for the first body sensing device to establish a direct communication connection with the body central device.

In this implementation manner, in a case in which a transmission channel of the detection signal is seriously blocked, it is possible that the first body sensing device cannot receive the at least one detection signal at all; in this case, the second connection determining module 330 may determine, according to a fact that the first body sensing device does not obtain the at least one detection signal in a set detection signal sending condition, that at this time it is not suitable for the first body sensing device to establish a direct communication connection with the body sensing device.

As shown in FIG. 4c, in a possible implementation manner, the second connection determining module 330 may comprise:

a first connection determining module 331, configured to: in response to a fact that the first body sensing device does not obtain the at least one detection signal within set period duration, determine that it is not suitable for the first body sensing device to establish a direct communication connection with the body central device.

For a further description of the function of the first connection determining module 331, refer to corresponding descriptions in embodiments shown in FIG. 1 and FIG. 2.

As shown in FIG. 4d, in a possible implementation manner, the second connection determining module 330 may comprise:

a second connection determining module 332, configured to: in response to a fact that the first body sensing device does not obtain the at least one detection signal in a condition that motion posture change information of a user meets a set standard, determine that it is not suitable for the first body sensing device to establish a direct communication connection with the body central device, where the user is a user using the first body sensing device and the at least one second body sensing device.

The set standard herein may be, for example, that: displacement of a user meets a set distance; and/or the body of a user rotates at a set angle, or the like.

For a further description of the function of the second connection determining module 332, refer to corresponding descriptions in the embodiments shown in FIG. 1 and FIG. 2.

Certainly, in another possible implementation manner, the second connection determining module 330 may comprise both the first connection determining module 331 and the second connection determining module 332 that are described above. Alternatively, it can be known by a person skilled in the art that the second connection determining module 330 may further comprise another connection determining unit, and the corresponding detection signal sending condition may also be another condition that may trigger sending of the detection signal.

In a possible implementation manner, the second connection determining module 330 is further configured to acquire the at least one detection signal from the body central device.

As shown in FIG. 4e, in a possible implementation manner, the device 300 comprises:

a third connection determining module 340, configured to: in response to a fact that the first body sensing device cannot send at least one signal to the body central device to a set data transmission standard, determine that it is not suitable for the first body sensing device to establish a direct communication connection with the body central device.

In this implementation manner, the data transmission standard may comprise, for example, at least one of the following: sending out data within a preset time period, a data transmission speed, and the like.

As shown in FIG. 4a, in a possible implementation manner, the communications module 310 comprises:

a first communications unit 311, configured to: in response to a fact that the first body sensing device has a direct communication connection channel with at least one of the at least one second body sensing device:

establish communication with the body central device by using the at least one of the at least one second body sensing device.

In a possible implementation manner, the direct communication connection channel between the first body sensing device and the second body sensing device may be, for example: a wired connection channel, or a channel using a human body as a connection medium.

As shown in FIG. 4a, in a possible implementation manner, the communications module 310 further comprises:

a second communications unit 312, configured to: in response to a fact that the first body sensing device has no direct communication connection channel with at least one of the at least one second body sensing device:

establish communication with the body central device by using a third body sensing device that has a direct communication connection channel with at least one of the at least one second body sensing device, and the at least one of the at least one second body sensing device, where it is not suitable for each of the third body sensing device to be directly connected to the body central device.

It can be seem from the foregoing description that by using the technical solutions of this embodiment of the subject application, within a normal communication range, regardless of gesture or location of a user, all body sensing devices at different locations on the body of the user can establish good communication connections with a body central device, thereby avoiding that the user cannot seamlessly and continuously collect body sensing data used for health detection due to communication interruption.

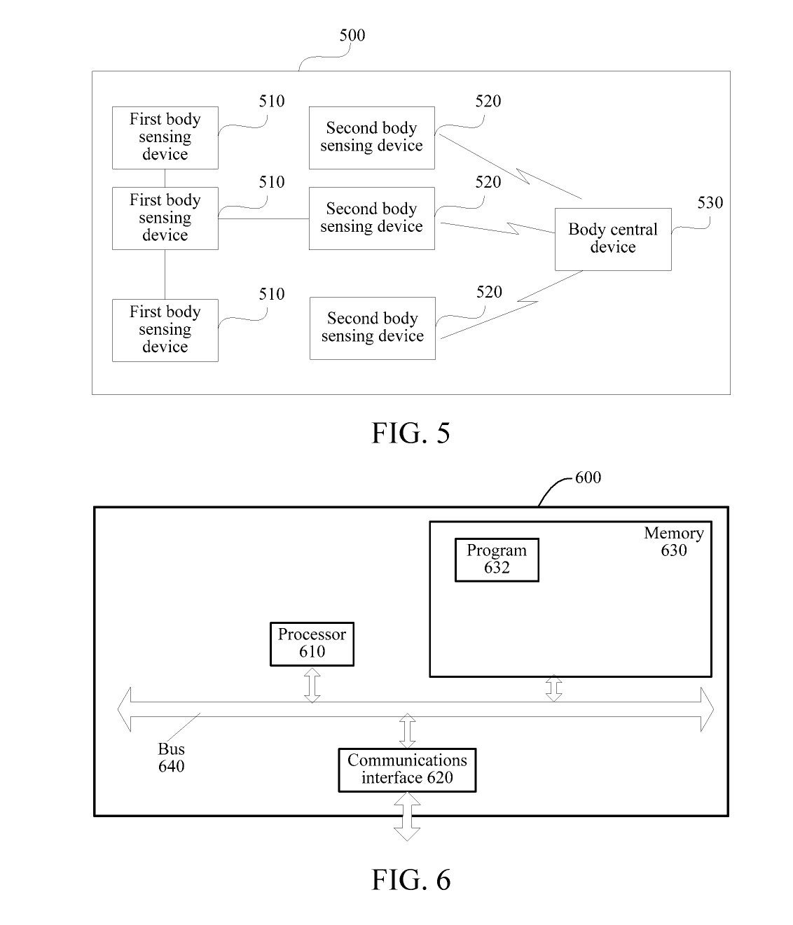

As shown in FIG. 5, an embodiment of the subject application further provides a body area network system 500, comprising multiple body sensing devices and one body central device 530.

The multiple body sensing devices comprise at least one first body sensing device 510 and at least one second body sensing device 520. It is not suitable for the at least one first body sensing device 510 to be in a direct communication connection with the body central device 530, it is suitable for the at least one second body sensing device 520 to be in a direct communication connection with the body central device 530, and there is a communication connection channel between at least one of the at least one body sensing device 510 and at least one of the at least one second body sensing device 520. The at least one second body sensing device 520 may communicate with each other.

Each of the at least one first body sensing device 510 may be the first body sensing device described in the implementation manner shown in FIG. 2, FIG. 3, or FIG. 4a to FIG. 4e. The second body sensing device 520 and the body central device 530 may also be devices corresponding to the descriptions in the foregoing implementation manners.

For an application scenario of the body area network system 500, refer to corresponding descriptions of the devices in the embodiment shown in FIG. 2.

In this implementation manner of this embodiment of the subject application, when it is not suitable for a first body sensing devices on the body of a user to communicate with a body central device, other body sensing device(s) for which it is suitable to communicate with the body central device will be used for the communication between the one or more body sensing devices and the body central device, which improves an effect of communication between a body sensing device and a body central device in a body area network, thereby avoiding insufficient detection of user health or the like due to blocked communication.

FIG. 6 is a schematic structural diagram of still another first body sensing device 600 according to an embodiment of the subject application. A specific implementation of the first body sensing device 600 is not limited in a specific embodiment of the subject application. As shown in FIG. 6, the first body sensing device 600 may comprise:

a processor 610, a communications interface 620, a memory 630, and a communications bus 640.

The processor 610, the communications interface 620, and the memory 630 communicate to one another by using the communications bus 640.

The communications interface 620 is configured to communicate with a network element of a client or the like.

The processor 610 is configured to perform a program 632, and specifically, may perform related steps in the foregoing method embodiment.

Specifically, the program 632 may comprise program code, and the program code comprises a computer operation instruction.

The processor 610 may be a central processing unit (CPU), or an application-specific integrated circuit (ASIC), or is configured as one or more integrated circuits implementing this embodiment of the subject application.

The memory 630 is configured to store the program 632. The memory 630 may comprise a high-speed RAM memory, or may further comprise a non-volatile memory, for example, at least one magnetic disk memory. The program 632 may specifically be configured to cause the first body sensing device 600 to perform the following steps:

determining whether it is suitable for a first body sensing device to establish a direct communication connection with a body central device,

if not, establishing communication with the body central device by using at least one second body sensing device.

For specific implementations of the steps in the program 632, reference may be made to corresponding descriptions in corresponding steps and units in the foregoing embodiments, which are not described herein again. It can be clearly learned by a person skilled in the art that for ease and brevity of description, for specific working processes of the devices and modules described above, reference may be made to corresponding process descriptions in the foregoing method embodiment, which are not described herein again.

A person of ordinary skill in the art may be aware that, exemplary units and method steps described with reference to the embodiments disclosed in this specification can be implemented by electronic hardware or a combination of computer software and electronic hardware. Whether these functions are performed by hardware or software depends on specified applications and design constraint conditions of the technical solutions. A person skilled in the art may use different methods to implement the described functions for each specified application, but such an implementation should not be construed as a departure from the scope of the subject application.

If the function is implemented in a form of a software functional unit and is sold or used as an independent product, the product may be stored in a computer-readable storage medium. Based on such an understanding, the technical solutions of the subject application essentially, or the part contributing to the prior art, or a part of the technical solutions may be implemented in a form of a software product. The computer software product is stored in a storage medium and comprises several instructions for causing a computer device (which may be a personal computer, a server, a network device, or the like) to perform all or some of the steps of the methods described in the embodiments of the subject application. The foregoing storage medium comprises: any medium that can store program code, such as a USB flash drive, a removable hard disk, a read-only memory (ROM), a random access memory (RAM), a magnetic disk, or an optical disc.

The foregoing implementation manners are only used to describe the subject application, but not to limit the subject application. A person of ordinary skill in the art can still make various alterations and modifications without departing from the spirit and scope of the subject application; therefore, all equivalent technical solutions also fall within the scope of the subject application, and the patent protection scope of the subject application should be subject to the claims.

1. A body area network data transmission method, comprising:
determining whether it is suitable for a first body sensing device to establish a direct communication connection with a body central device,
if it is determined not suitable, establishing communication with the body central device by using at least one second body sensing device.

2. The method of claim 1, wherein:
in response to that strength of at least one detection signal acquired by the first body sensing device is less than a set strength threshold, determining it is not suitable for the first body sensing device to establish a direct communication connection with the body central device.

3. The method of claim 1, wherein:
in response to that the first body sensing device does not obtain at least one detection signal in a set detection signal sending condition, determining it is not suitable for the first body sensing device to establish a direct communication connection with the body central device.

4. The method of claim 3, wherein the detection signal sending condition comprises that:
timing meets a set period duration.

5. The method of claim 3, wherein the detection signal sending condition comprises that:
motion posture change information of a user meets a set standard, wherein the user is a user using the first body sensing device and the at least one second body sensing device.

6. The method of claim 2, wherein the method further comprises:
acquiring the at least one detection signal from the body central device.

7. The method of claim 1, wherein:
in response to that the first body sensing device cannot send at least one signal to the body central device according to a set data transmission standard, determining it is not suitable for the first body sensing device to establish a direct communication connection with the body central device.

8. The method of claim 1, wherein establishing communication with the body central device by using at least one second body sensing device comprises:
in response to that the first body sensing device has a direct communication connection channel with at least one of the second body sensing device:
establishing communication with the body central device by using the at least one of the second body sensing device.

9. The method of claim 1, wherein establishing communication with the body central device by using at least one second body sensing device further comprises:
in response to that the first body sensing device has no direct communication connection channel with the at least one second body sensing device,
establishing communication with the body central device by using a third body sensing device that has a direct communication connection channel with the at least one second body sensing device.

10. A body sensing device, comprising:
a communications module, configured to:
in response to that it is not suitable for the body sensing device to establish a direct communication connection with a body central device,
establish communication with the body central device by using at least one second body sensing device.

11. The device of claim 10, wherein the device further comprises:
a connection determining module, configured to determine whether it is suitable for the body sensing device to establish a direct communication connection with the body central device.

12. The device of claim 11, wherein the connection determining module is further configured to: in response to that strength of at least one detection signal acquired by the body sensing device is less than a set strength threshold, determine that it is not suitable for the body sensing device to establish a direct communication connection with the body central device.

13. The device of claim 11, wherein the connection determining module is further configured to: in response to that the first body sensing device does not obtain at least one detection signal in a set detection signal sending condition, determine that it is not suitable for the body sensing device to establish a direct communication connection with the body central device.

14. The device of claim 13, wherein the connection determining module comprises:
a first connection determining module, configured to: in response to that the first body sensing device does not obtain the at least one detection signal within a set period duration, determine that it is not suitable for the body sensing device to establish a direct communication connection with the body central device.

15. The device of claim 13, wherein the connection determining module comprises:
a second connection determining module, configured to: in response to that the body sensing device does not obtain the at least one detection signal in a condition that motion posture change information of a user meets a set standard, determine that it is not suitable for the first body sensing device to establish a direct communication connection with the body central device, wherein the user is a user using the body sensing device and the at least one second body sensing device.

16. The device of claim 12, wherein the connection determining module is further configured to acquire the at least one detection signal from the body central device.

17. The device of claim 11, wherein the connection determining module is further configured to: in response to that the body sensing device cannot send at least one signal to the body central device according to a set data transmission standard, determine that it is not suitable for the first body sensing device to establish a direct communication connection with the body central device.

18. The device of claim 10, wherein the communications module comprises:
a first communications unit, configured to: in response to that the body sensing device has a direct communication connection channel with the at least one second body sensing device,
establish communication with the body central device by using the at least one of the second body sensing device.

19. The device of claim 10, wherein the communications module comprises:
a second communications unit, configured to: in response to that the body sensing device has no direct communication connection channel with the at least one second body sensing device,
establish communication with the body central device by using the at least one first body sensing device that has a direct communication connection channel with the at least one second body sensing device.

20. A body area network system, comprising the body sensing device of claim 10, at least one second body sensing device, and a body central device.

21. A computer readable storage device comprising executable instructions that, in response to execution, cause a device comprising a processor to perform operations, comprising:
in response to that it is not suitable for a first body sensing device to establish a direct communication connection with a body central device:
establishing communication with the body central device at least by using at least one of second body sensing device, wherein it is suitable for each of the at least one second body sensing device to establish a direct communication connection with the body central device.
